(19) United States
(12) Patent Application Publication
(10) Pub. No.: US 2026/0169903 A1
(43) Pub. Date: Jun. 18, 2026

(54) MACHINE LEARNING-BASED TEXT CLASSIFICATION

(71) Applicant: SAP SE, Walldorf (DE)

(72) Inventors: Raghuveer Kanneganti, Prosper, TX (US); Shrinivas Kaza, Danville, CA (US); Sumant Kumar, Union City, CA (US); Taiwo Alabi, Berkeley, CA (US); Daniel Cooley, Pittsburgh, PA (US); Vinay Mathur, Palo Alto, CA (US)

(21) Appl. No.: 18/980,724

(22) Filed: Dec. 13, 2024

(51) Int. Cl. G06F 11/3668; G06F 40/284; G06F 40/40

(52) U.S. Cl. CPC G06F 11/3692; G06F 40/284; G06F 40/40

(57) ABSTRACT

A system and method include training a classification model to classify data based on first data associated with a first usage scenario, receiving second data associated with a second usage scenario inputting the second data to the classification model and receiving a likelihood of a first classification from the classification model, determining a similarity between the second data and a plurality of data associated with the second usage scenario, modifying the likelihood based on the determined similarity, determining a second classification of the second data based on the modified likelihood, and processing the second data according to the second classification of the second data.

### BACKGROUND

Modern enterprises generate and store vast amounts of data. Software applications allow users to review, manage and analyze the stored data to assist enterprise processes. During operation, faults may occur in the processes and in the software applications themselves. For example, a software application may receive a request which should be rejected, or users may be unable to log into the software application.

The detection of faults and the proper prioritization of faults are crucial. Undetected faults may cause costly operational errors and/or downtime, while improper prioritization of faults may squander remedial resources or unnecessarily degrade performance. Due to the importance of detection and prioritization, many software application providers deploy teams of experts to monitor systems and prioritize any detected faults. This arrangement is time-consuming and cost-inefficient.

What is needed are systems to efficiently detect and classify faults/errors occurring within a software application such that those faults/errors may be resolved in a resource-efficient manner.

### BRIEF DESCRIPTION OF THE DRAWINGS

FIG. 1 illustrates a system to classify text data according to some embodiments.

FIG. 2 is a flow diagram of a process to classify text data according to some embodiments.

FIG. 3 illustrates extraction of text data from a first usage scenario according to some embodiments.

FIG. 4 illustrates generation of training data according to some embodiments.

FIG. 5 illustrates prompting of a text generation model according to some embodiments.

FIG. 6 illustrates training of a classification model according to some embodiments.

FIG. 7 illustrates reception of text data from a second usage scenario according to some embodiments.

FIG. 8 illustrates boosted classification of text data from a second usage scenario according to some embodiments.

FIG. 9 is a user interface of a document classification application according to some embodiments.

FIG. 10 is a diagram of a cloud-based implementation according to some embodiments.

### DETAILED DESCRIPTION

The following description is provided to enable any person in the art to make and use the described embodiments. Various modifications, however, will be readily-apparent to those in the art.

Embodiments may address the foregoing by training a machine learning classification model on historical text data generated in a first usage scenario, and employing a boosting strategy to allow the machine learning model to be effectively used to classify text data generated in a second usage scenario. This may allow for accurate detection and classification of issues which were not present in the historical text data.

For example, the boosting strategy may be applied if the trained model classifies the text data of the second usage scenario as having a low probability of representing a critical issue, scrutiny. In such a case, a similarity is determined between the semantics of the text data and the semantics of known issues of the second usage scenario. If a high degree of similarity is detected, a boosting factor is applied to the output probability, potentially reclassifying the text data into a more-critical issue category.

The foregoing approach advantageously adapts the trained model to evolving environments and can detect issues and their severities even if they deviate from established patterns. Moreover, embodiments may provide improved issue prioritization and resulting response time, enhanced accuracy and consistency of issue detection, improved allocation of resources for addressing issues via improved issue prioritization and resulting cost savings.

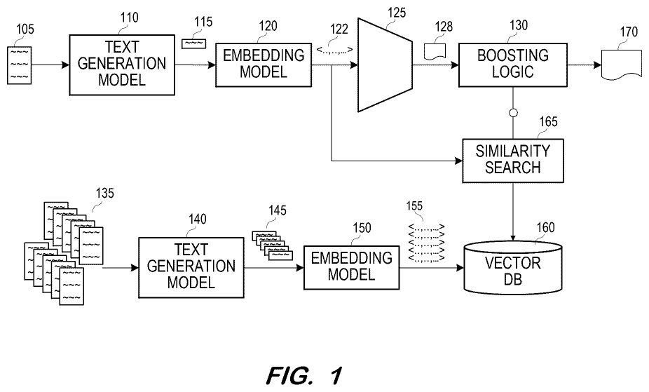

FIG. 1 illustrates an architecture to classify text data according to some embodiments. Each of the illustrated components may be implemented using any suitable combination of local, on-premise, cloud-based, distributed (e.g., including distributed storage and/or compute nodes) computing hardware and/or software that is or becomes known. Each component described herein may be executed by one or more physical and/or virtualized servers.

Two or more components of FIG. 1 may be co-located. In some embodiments, two or more components are implemented by a single computing device. One or more components may be implemented by a cloud service (e.g., Software-as-a-Service, Platform-as-a-Service). A cloud-based implementation of any components of FIG. 1 may apportion computing resources elastically according to demand, need, price, and/or any other metric. Each component may be executed by an execution environment comprising one or more servers, virtual machines, clusters of a container orchestration system, etc. Such an execution environment may provide an operating system, services, I/O, storage, libraries, frameworks, etc. to applications executing therein.

Text data 105 may comprise any text object generated by a software application (not shown). Text data 105 may comprise, but is not limited to, a response to a procurement request (i.e., a request for proposal (RFP)) including project scope, timelines, evaluation criteria, costs and contractual terms, an invoice including items, quantities and prices, or a support ticket including a summary, description and comments. The remaining components of FIG. 1 are intended to classify text data 105. The classification may comprise any binary or multi-class classifications that are or become known, including but not limited to Approve/Not Approved, Error/No Error, Non-Critical/Critical, for example.

Text generation model 110 receives text data 105. Text generation model 110 may comprise a neural network trained to generate text based on input text. Text generation model 110 may be implemented by, for example, executable program code, a set of hyperparameters defining a model structure and a set of corresponding weights, or any other representation of an input-to-output mapping which was learned as a result of the training. Model 110 may be publicly available or deployed within a trusted landscape. Similarly, text generation model 110 may be trained based on public and/or private data.

According to some embodiments, model 110 is a Large Language Model (LLM) or a Small Language Model (SLM) conforming to a transformer architecture. Non-exhaustive examples of an LLM include GPT-4, LaMDA, LLAMA, Mistral, Mixtral and Claude, and of an SLM include DistilBERT, BART, T5, and MiniLM. A transformer architecture may include, for example, embedding layers, feedforward layers, recurrent layers, and attention layers. An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention or other types of attention mechanisms to enable context understanding across a given set of words as well as for computational efficiency. Generally, each layer includes nodes which are connected to the input of nodes of a subsequent layer to form a directed and weighted graph. Each node receives input, changes its internal state according to that input, and produces an output depending on the input and internal state.

Text data 105 may be transmitted to model 110 with a prompt which instructs model 110 to summarize text data 105. Accordingly, text generation model 110 generates text summary 115. Text summary 115 is provided to embedding model 120, which is pre-trained to generate an embedding (i.e., a multi-dimensional numerical vector) intended to capture the semantic and syntactic meaning of input text. Embedding model 120 may also be implemented by executable program code, a set of hyperparameters defining a model structure and a set of corresponding weights, or any other representation of an input-to-output mapping. Examples of embedding models include text embedding, ada embeddings and embedding analogs of open-source language models.

Embedding model 120 generates embedding 122 and inputs embedding 122 to trained classification model 125. Classification model 125 may comprise any type of supervised learning-trained classification model that is or becomes known, including but not limited to a kernel Support Vector Machine, a naïve Bayes model, a decision tree, and a random forest. Classification model 125 may comprise an unsupervised learning model such as a DBSCAN model, or a Latent Dirichlet Allocation (LDA) model. In a less compute-constrained environment, model 125 may be an Agent that is tuned specifically for such a task or a fine-tuned SLM, e.g., a BERT model, with its head removed and hence having a classification final layer.

Model 125 operates based on its training to generate classification 128 corresponding to text data 105. As is known in the art, classification 128 may comprise a probability corresponding to each classification which model 125 was trained to recognize.

Notably, model 125 has been trained based on text data associated with a first usage scenario which is different from a second usage scenario with which text data 105 is associated. The second usage scenario may be associated with issue patterns which are different from those of the first usage scenario and are therefore not reflected in the text data which was used to train model 125. For example, the first usage scenario may be a first procurement application of a first tenant, and the second usage scenario may be a second procurement application of a second tenant. Text data 105 is a response to an RFP of the second procurement application and model 125 has been trained on RFP responses of the first procurement application to classify RFP responses as Approved/Not Approved. The fields and logic of the first procurement application may differ from the fields and logic of the second procurement application. Even if the fields and logic do not differ, the content of RFPs issued by the first procurement application might differ from that of the second procurement application. Accordingly, the ability of model 125 to accurately classify RFP responses of the second procurement application might be weaker than its ability to classify RFP responses of the first procurement application.

In another example, text data 105 is a support ticket associated with operation of a second software application. The support ticket may indicate a complaint received from a user of the second software application and may be received from a user support application. Model 125, on the other hand, was trained to classify support tickets as Non-critical/Critical based on support tickets which indicate complaints received from users of a first software application. The support tickets used for training may have been from the same user support application from which text data 105 is received or from a different support application). Since the first software application differs from the second software application, the mappings of support ticket data to classifications which were learned by model 125 during training might not be effective to accurately classify support tickets which are associated with the second application.

Boosting logic 130 modifies classification 128 as will be described in detail below. Generally, boosting logic 130 modifies classification 128 based on a similarity between text data 105 and text data 135. Text data 135 is associated with the second usage scenario and may be logically related to the classification task of model 125. With respect to the above examples, text data 135 may comprise RFP responses of a second procurement application which have been identified as problematic, or descriptions of prioritized expense categories of the second procurement application. In another case, text data 135 may comprise quality assurance tickets which were generated during development and/or testing of a second software application. Embodiments are not limited thereto.

Text generation model 140, which may comprise the same model as text generation model 110, generates text summaries 145 based on text data 135 and corresponding prompts. Embedding model 150, which again may be identical to embedding model 120, generates embeddings 155, each of which corresponds to one of summaries 145. Vector database 160 stores embeddings 155 and may comprise any implementation of a vector database that is or becomes known.

Boosting logic 130 queries similarity search component 165, which may comprise an API, to identify an embedding of vector database 160 which is closest to embedding 122. Similarity search component 165 and vector database 160 may be optimized to quickly determine distances between an input multi-dimensional vector (e.g., embedding 122) and stored multi-dimensional vectors (e.g., embeddings 155) and return a closest stored embedding. Similarity search component 165 may also return a numerical indication of the degree of similarity between embedding 122 and the closest one of embeddings 155.

Boosting logic 130 may apply any suitable logic to modify classification 128 based on the contents of classification 128 and on the returned degree of similarity. In one non-exhaustive example, boosting logic 130 queries similarity search component 165 as described above if the likelihood of a target classification (e.g., invalid, critical) output by model 125 is less than a first threshold amount (e.g., 0.4). If the maximum similarity returned by component 165 is greater than a second threshold amount (e.g., 0.8), a boosting factor is added to the likelihood of the target classification, resulting in classification 170. If the maximum similarity returned by component 165 is less than the second threshold, classification 128 is unchanged (i.e., classification 170=classification 128). Classification 128 is also unchanged if the likelihood of the target classification output by model 125 is greater than the first threshold amount.

A system may act based on classification 170. For example, classification 170 may be returned to the procurement system from which text data 105 (i.e., an RFP response) was received. If classification 170 indicates a high probability that text data 105 is invalid, the procurement system may execute its processes for rejecting the response. Assuming text data 105 is a support ticket associated with a second software application, a support application may triage the support ticket based on a classification and likelihood indicated by classification 170 (e.g., high likelihood of criticality, medium likelihood of criticality, low likelihood of criticality).

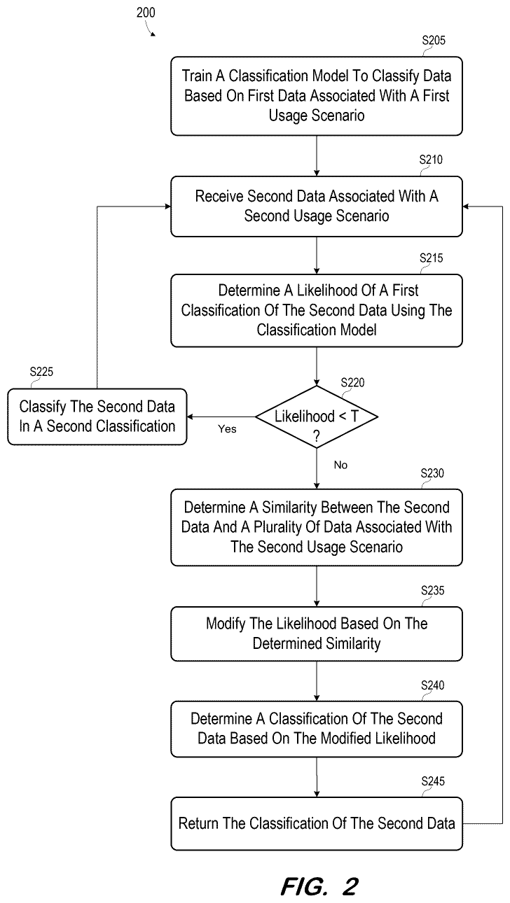

FIG. 2 comprises a flow diagram of process 200 to classify text according to some embodiments. Process 200 and the other processes described herein may be performed using any suitable combination of hardware and software. Software program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

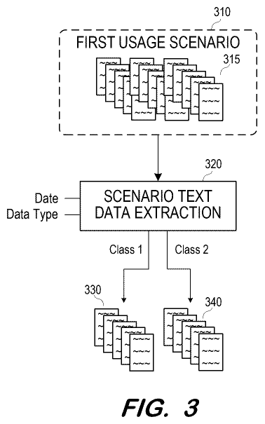

Initially, at S205, a classification model is trained to classify data based on first data associated with a first usage scenario. An example of S205 will be described below with reference to FIGS. 3-6. FIG. 3 illustrates extraction of first data from a first usage scenario according to some embodiments. As described above, first usage scenario 310 may comprise a software application executed by a particular organization at a particular time. Text data 315 may comprise responses to RFPs, invoices, support tickets, or any other data to be classified according to some embodiments.

Scenario text data extraction component 320 may select particular ones of text data 315 based on specified filters. For example, a Date filter may allow extraction of more-recent text data 315. A Data Type filter may be used to select particular types of text data 315, such as selection of only text data 315 associated with a Defect type, as opposed to Feature Request, Task or Incident types. According to some embodiments, component 320 also extracts instances of text data 315 which are linked to those instances of text data 315 that are extracted based on their Date and Data Type. The extracted instances are illustrated as text data 330 and are associated with Class 1 in the present example.

In order to provide a desirable distribution of training data, extraction component 320 also extracts a similar number of unselected text data 315 having the same date range as the selected text data 315. If the selected text data 315 is associated with various sub-scenarios (e.g., distinct projects which use the first usage scenario), the unselected text data 315 may be extracted to have a sub-scenario distribution similar to the distribution of the sub-scenarios within the selected text data 315. The extracted unselected instances of text data 315 are illustrated as text data 340 and associated with Class 2.

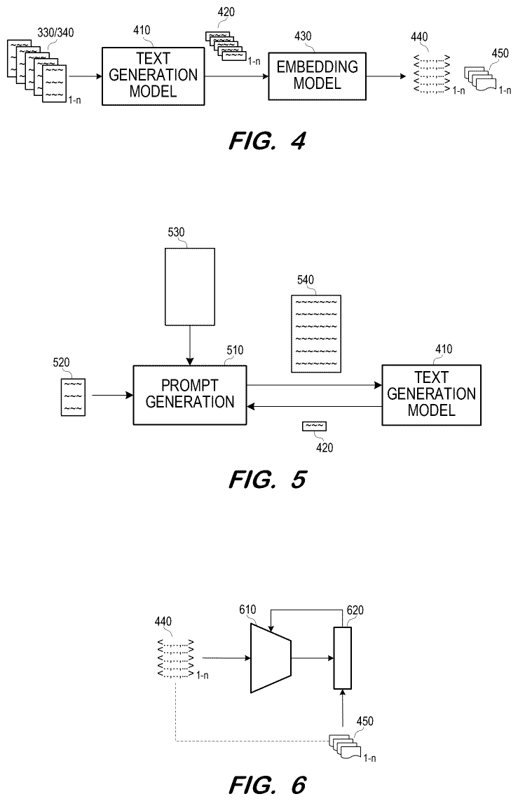

Continuing with the example of S205, FIG. 4 illustrates generation of training data from the extracted test data according to some embodiments. In some examples, each of text data 330 and 340 is a support ticket comprising a summary, description and comments. Text generation model 410 receives text data 330 and 340 and generates summaries 420 therefrom. Specifically, text generation model 410 generates each summary 420 based on a respective one of text data 330 and 340. As mentioned above, text data 330 and 340 may be transmitted to model 410 with a prompt which instructs model 410 to summarize text data 330 and 340.

FIG. 5 illustrates prompting of a text generation model according to some embodiments. Prompt generation component 510 (not shown in FIG. 4) receives text data 520. Prompt generation component 510 uses prompt template 530 and text data 520 to generate prompt 540 and transmits prompt 540 to text generation model 410. According to some embodiments, prompt generation component 510 populates prompt template 530 with text data 520 to generate prompt 540. In some embodiments, prompt template 530 is transmitted to text generation model 410 as a system prompt and text data 520 is transmitted to text generation model 410 as a user prompt.

Prompt template 530 according to some embodiments may include the following, formatted as a system prompt: “You are tasked with reviewing the summary, description, and comments of a project tracking ticket. Based on this information, please summarize the key issue that the ticket is addressing in 5 sentences or less. Make sure to focus on the root cause of the issue, key details, and any proposed solutions or next steps.”

Text generation model 410 generates and returns summary 420 based on prompt 540. The foregoing is repeated for each of text data 330 and 340, resulting in summaries 420. Summaries 420 are provided to embedding model 430, which generates an embedding 440 representing each of summaries 420. Each of classifications 450 of FIG. 4 is associated with a respective embedding 440 and indicates a classification (i.e., Class 1 or Class 2) of the text data 330 or 340 from which its respective embedding was generated.

Continuing with the present example of S205, FIG. 6 illustrates training of a classification model based on training data composed of embeddings 440 and classifications 450 according to some embodiments. Model 610 may comprise a Support Vector Machine (SVM) classifier configured with a Radial Basis Function kernel. Other kernels, such as linear, polynomial or Laplacian kernels may be used. Model 610 may exhibit an architecture other than SVM.

Embeddings 440 are organized into training batches and a batch is fed to model 610. Loss layer 620 receives the resulting predictions from model 610 and calculates a loss (e.g., using a Hinge loss function) which quantifies a discrepancy between the predictions and the classifications 450 which correspond to the embeddings of the batch. The calculated loss is back-propagated to adjust the internal weights of model 610, a next batch of embeddings 440 is input, and the process repeats. This iterative training and loss propagation culminate in a trained model which has learned to discriminate between classes within text data 330 and 340 based on embeddings 440. In some embodiments, the training process is effected using a BERT model with 764 dimensions and a top-layer that is replaced with a classifier or classification model, thus creating a binary or multi-class classifier. The trained model is preserved as an artifact for future use in classifying new text data.

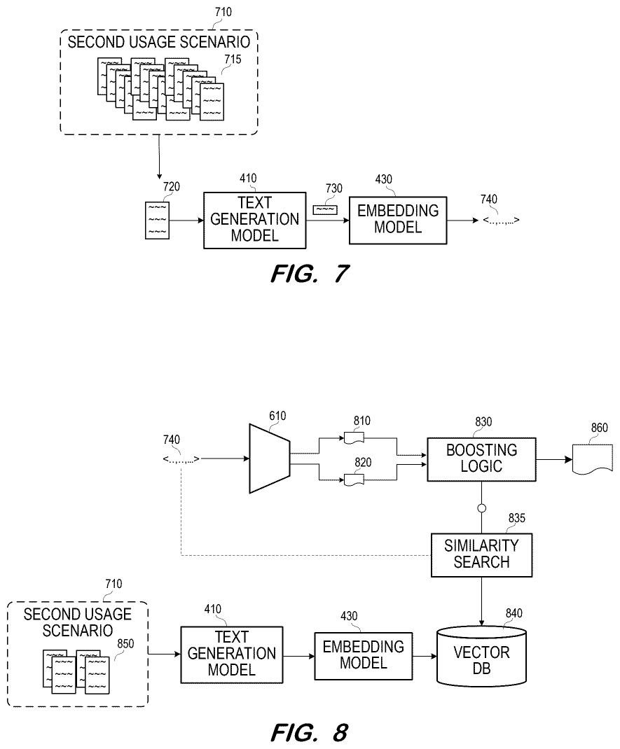

Returning to process 200, second data associated with a second usage scenario is received at S210. FIG. 7 illustrates extraction of text data 720 from text data 715 of second usage scenario 710 according to some embodiments. Second usage scenario 710 may differ from first usage scenario 310 in terms of the executing software application, the organization, and/or the time. As described above, the patterns relating the data of the second usage scenario to the classifications of the second usage scenario may be different from the patterns of the first usage scenario and are therefore not reflected in the first data which was used to train the model at S205.

Next, at S215, the trained classification model is used to determine the likelihood of a first classification of the second data. Referring to FIG. 7, text data 720 is input (along with a suitable prompt) to text generation model 410 to generate summary 730, which is input to embedding model 430 to generate embedding 740. FIG. 8 illustrates input of embedding 740 to trained model 610 to generate likelihoods for each of two different classifications 810 and 820.

The first classification may comprise a target, or anomalous, classification such as invalid or critical. If it is determined at S220 that the likelihood of the first classification output by model 610 is less than a threshold, boosting logic 830 outputs classification 860 which classifies the second data into the second classification at S225. Flow then returns to S210 to await reception of other second data from the second usage scenario.

Flow proceeds from S220 to S230 if the likelihood of the first classification output by model 610 is greater than the threshold. At S230, a similarity between the second data and a plurality of data associated with the second usage scenario is determined. Referring to FIG. 8, boosting logic 830 may query similarity search component 835 to identify an embedding of vector database 840 which is most-similar to embedding 740 and return its similarity.

FIG. 8 depicts text data 850 associated with second usage scenario 710. As mentioned above, text data 850 is associated with second usage scenario 710 and may be logically related to the classification task of model 610. Text generation model 410 generates text summaries based on text data 850 and corresponding prompts as mentioned above. Embedding model 430 generates an embedding for each text summary and vector database 840 stores the generated embeddings 155.

The likelihood determined at S215 is modified at S235 based on the similarity determined at S230. In one example, the likelihood is unmodified if the determined similarity is less than a threshold. If the similarity is greater than the threshold, a boosting factor (e.g., 0.43) is added to the likelihood. The magnitude of the boosting factor may be inversely related to the magnitude of the similarity.

Modification of the likelihood in this manner serves to alter the output of the trained model in view of patterns of the current usage scenario. This modification is helpful in cases where the second usage scenario has not yet generated an adequate amount of text data from which an accurate classification model can be trained.

A classification of the second data is determined based on the modified likelihood at S240. The classification may differ from the potential output classifications of the trained model. For example, the determined classification may be a sub-classification of the first classification. According to some embodiments, the determined classification is critical-medium if the modified likelihood is between 0.4 and 0.8, and is critical-high if the modified likelihood is greater than or equal to 0.8.

The classification of the second data is returned at S245. The classification may be returned to the second usage scenario so that the second data may be processed according to the classification. For example, in a case that the second data is a support ticket, the support ticket may be processed by IT support at a normal priority if the classification indicates that the support ticket should be handled at the normal priority and processed by IT support at a high priority if the classification indicates that the support ticket should be handled at the high priority. Alternatively, in a procurement scenario where the second data is a procurement request, the determined classification may indicate a high probability that the procurement request corresponds to a Not Approved classification, and processes of the second usage scenario for rejecting the procurement request may therefore be executed.

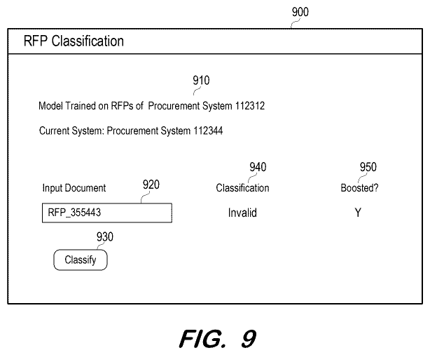

FIG. 9 is a user interface of a classification application according to some embodiments. A user may operate a user device to access a classification application, for example by operating a Web browser to access a landing page of the classification application. In another example, a user accesses user interface 900 through another application, for example by instructing the other application to classify a text document.

User interface 900 includes information 910 specifying the usage scenario (i.e., Procurement System 112312) which generated the text data on which a classification model (e.g., model 125) was trained and an identifier of the current usage scenario (i.e., Procurement System 112344). Input field 920 allows the user to specify text data of the current usage scenario to be classified. Accordingly, upon selection of Classify control 930, a process such as S210-S245 of process 200 is executed to determine a classification of the specified text data of the current usage scenario.

The determined classification is presented in field 940. Field 950 also indicates whether the classification was determined based on a likelihood which was boosted as described herein. That is, field 950 indicates whether the likelihood based on which the classification was determined was modified based on a similarity of the specified text data to other text data of the current usage scenario.

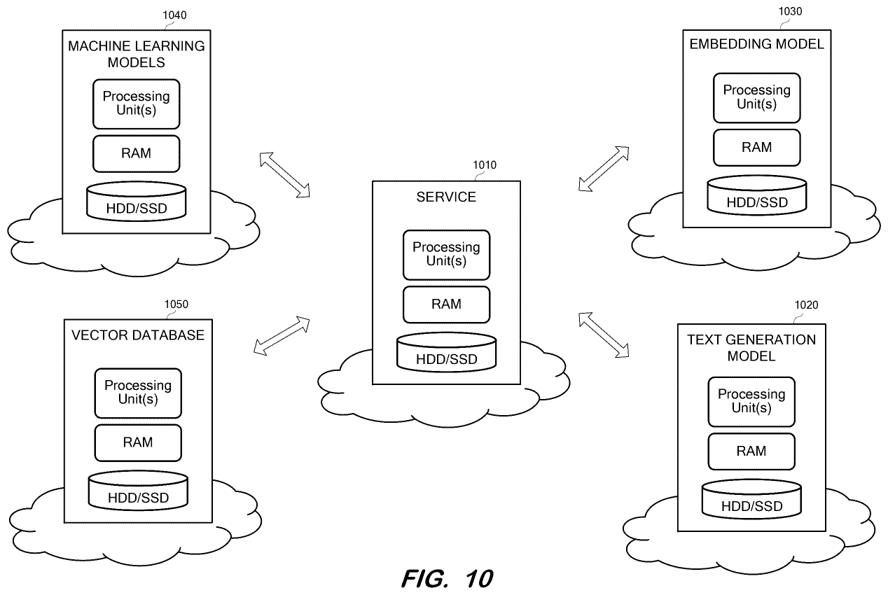

FIG. 10 is a diagram of a cloud-based implementation according to some embodiments. Service 1010 may provide any known functionality to a user and generate embeddings as described herein. Service 1010 requests a summary of text data from text generation model 1020 and requests an embedding of the summary from embedding model 1030. Service 1010 may request a classification from a trained model of machine learning models 1040 and may then determine whether to modify a likelihood of the classification based on similarities between the embedding and embeddings stored in vector database 1050. Service 1010 determines a classification based on the likelihood and processes the text data based on the classification.

Each of systems 1010 through 1050 may comprise cloud-based resources residing in one or more public clouds providing self-service and immediate provisioning, autoscaling, security, compliance and identity management features. Each of systems 1010 through 1050 may comprise servers or virtual machines of respective Kubernetes clusters, but embodiments are not limited thereto.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable recording media. Such media may include, for example, a hard disk, a DVD-ROM, a Flash drive, magnetic tape, and solid-state Random Access Memory (RAM) or Read Only Memory (ROM) storage units. The program code may be optimized to run on a graphics processing unit (GPU) where computation can be accelerated over many GPUs to enable more efficient and less latent inferences. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A method comprising:
training a classification model to classify data based on first data associated with a first usage scenario;
receiving second data associated with a second usage scenario different from the first usage scenario;
inputting the second data to the classification model and receiving a likelihood of a first classification from the classification model;
determining a similarity between the second data and a plurality of data associated with the second usage scenario;
modifying the likelihood based on the determined similarity;
determining a second classification of the second data based on the modified likelihood; and
processing the second data according to the second classification of the second data.

2. The method of claim 1, wherein determining a similarity between the second data and the plurality of data comprises:
prompting a text generation model to generate a summary of the second data;
generating an embedding based on the summary; and
determining similarities between the embedding and each of a plurality of embeddings representing the plurality of data.

3. The method of claim 2, wherein inputting the second data to the classification model comprises:
inputting the embedding to the classification model.

4. The method of claim 1, wherein the first usage scenario comprises a first procurement scenario, and
wherein the second usage scenario comprises a second procurement scenario.

5. The method of claim 4, wherein the first data comprises responses to procurement requests associated with the first procurement scenario, and
wherein the plurality of data associated with the second usage scenario comprises descriptions of prioritized expense categories of the second procurement scenario.

6. The method of claim 1, wherein the first usage scenario comprises operation of a first software application, and
wherein the second usage scenario comprises operation of a second software application.

7. The method of claim 6, wherein the first data comprises support tickets associated with the first software application, and
wherein the plurality of data associated with the second usage scenario comprises quality assurance tickets associated with the second software application.

8. A system comprising:
a memory storing executable program code; and
at least one processing unit to execute the program code to cause the system to perform operations comprising:
receiving second data associated with a second usage scenario different from a first usage scenario;
inputting the second data to a classification model trained to classify data based on first data associated with the first usage scenario;
receiving a likelihood of a first classification from the classification model;
determining a similarity between the second data and a plurality of data associated with the second usage scenario;
modifying the likelihood based on the determined similarity;
determining a second classification of the second data based on the modified likelihood; and
processing the second data according to the second classification of the second data.

9. The system of claim 8, wherein determining the similarity between the second data and the plurality of data comprises:
prompting a text generation model to generate a summary of the second data;
generating an embedding based on the summary; and
determining a maximum similarity between the embedding and each of a plurality of embeddings representing the plurality of data.

10. The system of claim 9, wherein inputting the second data to the classification model comprises:
inputting the embedding to the classification model.

11. The system of claim 8, wherein the first usage scenario comprises a first procurement scenario, and
wherein the second usage scenario comprises a second procurement scenario.

12. The system of claim 11, wherein the first data comprises responses to procurement requests associated with the first procurement scenario, and
wherein the plurality of data associated with the second usage scenario comprises descriptions of prioritized expense categories of the second procurement scenario.

13. The system of claim 8, wherein the first usage scenario comprises operation of a first software application, and
wherein the second usage scenario comprises operation of a second software application.

14. The system of claim 13, wherein the first data comprises support tickets associated with the first software application, and
wherein the plurality of data associated with the second usage scenario comprises quality assurance tickets associated with the second software application.

15. One or more non-transitory computer-readable recording media storing program code, the program code executable by at least one processing unit of a computing system to cause the computing system to perform operations comprising:
receiving second text data associated with a second usage scenario different from a first usage scenario;
inputting the second text data to a classification model trained to classify text data based on first text data associated with the first usage scenario;
receiving a likelihood of a first classification from the classification model;
determining a similarity between the second text data and a plurality of text data associated with the second usage scenario;
modifying the likelihood based on the determined similarity;
determining a second classification of the second text data based on the modified likelihood; and
processing the second text data according to the second classification of the second data.

16. The one or more non-transitory computer-readable recording media of claim 15, wherein determining the similarity between the second text data and the plurality of text data comprises:
prompting a text generation model to generate a summary of the second text data;
generating an embedding based on the summary; and
determining a maximum similarity between the embedding and each of a plurality of embeddings representing the plurality of text data.

17. The one or more non-transitory computer-readable recording media of claim 16, wherein inputting the second text data to the classification model comprises:
inputting the embedding to the classification model.

18. The one or more non-transitory computer-readable recording media of claim 15, wherein the first usage scenario comprises a first procurement scenario, and
wherein the second usage scenario comprises a second procurement scenario.

19. The one or more non-transitory computer-readable recording media of claim 18, wherein the first data comprises responses to procurement requests associated with the first procurement scenario, and
wherein the plurality of text data associated with the second usage scenario comprises descriptions of prioritized expense categories of the second procurement scenario.

20. The system of claim 15, wherein the first usage scenario comprises operation of a first software application, wherein the second usage scenario comprises operation of a second software application, wherein the first text data comprises support tickets associated with the first software application, and wherein the plurality of text data associated with the second usage scenario comprises quality assurance tickets associated with the second software application.
